(19) United States
(12) Patent Application Publication
(10) Pub. No.: US 2013/0346221 A1
(43) Pub. Date: Dec. 26, 2013

(54) SYSTEMS AND METHODS FOR PROVIDING MERCHANTS WITH USER INTERFACES FOR MANAGING ONLINE DEALS

(71) Applicant: Elite Media Work LLC, Chicago, IL (US)

(72) Inventors: Sairam Rangachari, Chicago, IL (US); John T. Shave, Chicago, IL (US); Jared Antonyzyn, Chicago, IL (US)

(21) Appl. No.: 14/015,797

(22) Filed: Aug. 30, 2013

Related U.S. Application Data
(63) Continuation of application No. PCT/US2012/027600, filed on Mar. 2, 2012.
Application No. PCT/US2012/027600 is a continuation-in-part of application No. 13/187,432, filed on Jul. 20, 2011.
Application No. PCT/US2012/027600 is a continuation-in-part of application No. 13/187,431, filed on Jul. 20, 2011.
(60) Provisional application No. 61/448,846, filed on Mar. 3, 2011.
(60) Provisional application No. 61/481,710, filed on May 2, 2011.
(60) Provisional application No. 61/481,710, filed on May 2, 2011.

(51) Int. Cl. G06Q 30/02

(52) U.S. Cl. CPC G06Q 30/0277
USPC 705/14.73

(57) ABSTRACT

A computer system for e-commerce management includes a merchant user interface module configured to allow a merchant to define a deal for offering via a plurality of online distribution channels. The computer system further includes a business layer configured to use the defined deal to publish offers of the defined deal to the plurality of online distribution channels. The business layer aggregates data relating to the published offers and the plurality of online distribution channels. The merchant user interface module is further configured to allow the merchant to view the aggregated data and to make adjustments to the published offers.

### CROSS-REFERENCE TO RELATED APPLICATIONS

The present application is a continuation of International Application No. PCT/US2012/027600, filed Mar. 2, 2012, which claims the benefit of U.S. Provisional Application No. 61/448,846, filed Mar. 3, 2011. International Application No. PCT/US2012/027600 is also a continuation-in-part of both U.S. patent application Ser. No. 13/187,431, filed Jul. 20, 2011 and U.S. patent application Ser. No. 13/187,432, filed Jul. 20, 2011; both U.S. patent application Ser. No. 13/187,431 and U.S. patent application Ser. No. 13/187,432 claim the benefit of U.S. Provisional Application 61/481,710, filed May 2, 2011. International Application No. PCT/US2012/027600, U.S. Provisional Applications 61/448,846 and 61/481,710 and U.S. patent application Ser. Nos. 13/187,431 and 13/187,432 are each incorporated by reference herein in their entireties.

### BACKGROUND

The present disclosure relates generally to the field of discount offers of goods or services. More specifically, the present disclosure relates to computerized systems and methods for providing merchants with user interfaces for managing online deals.

Conventionally, retailers or service providers market directly to customers via in-store sales, coupons, advertisements, and the like. In some instances, a third party is used to offer deals online for a merchant. A representative from the third party typically works with the merchant to manually establish an approach for offering the deal.

### SUMMARY

One embodiment relates to a computer system for e-commerce management. The system includes a merchant user interface module configured to allow a merchant to define a deal for offering via a plurality of online distribution channels and a business layer configured to use the defined deal to publish offers of the defined deal to the plurality of online distribution channels. The business layer aggregates data relating to the published offers and the plurality of online distribution channels, and the merchant user interface module is further configured to allow the merchant to view the aggregated data and to make adjustments to the published offers.

Another embodiment relates to a computerized method for providing e-commerce management. The method includes presenting a merchant with a merchant user interface that allows the merchant to define a deal for offering via a plurality of distribution channels. The method further includes publishing offers of the defined deal to a plurality of online distribution channels. The method further includes aggregating data relating to the published offers and the plurality of online distribution channels. The method further includes providing, via the merchant user interface, a user interface tool for allowing the merchant to view the aggregated data and to make adjustments to the published offers.

Another embodiment relates to a computer-readable media having instructions stored thereon, which, when executed by a data processing apparatus, causes the data processing apparatus to perform operations. The operations include presenting a merchant with a merchant user interface that allows the merchant to define a deal for offering via a plurality of distribution channels, publishing offers of the defined deal to a plurality of online distribution channels, aggregating data relating to the published offers and the plurality of online distribution channels, and providing, via the merchant user interface, a user interface tool for allowing the merchant to view the aggregated data and to make adjustments to the published offers.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a computerized system for providing merchants with user interfaces for managing online deals, according to an exemplary embodiment;

FIG. 2 is a detailed block diagram of the business layer of FIG. 1, according to an exemplary embodiment;

FIG. 3 is an architecture block diagram of the computerized system of FIG. 1, according to an exemplary embodiment;

FIG. 4 is flow chart of a process for merchant and consumer use of the computerized system of FIG. 1, according to an exemplary embodiment;

FIG. 5 is a flow chart of a process for merchant interaction with the computerized system of FIG. 1, according to an exemplary embodiment;

FIG. 6 is an illustration of a graphical user interface for the computer system of FIG. 1, according to an exemplary embodiment;

FIGS. 7A-D are illustrations of graphical user interfaces for creating merchant offers, according to an exemplary embodiment;

FIGS. 8A-B are illustrations of an offer template, according to an exemplary embodiment;

FIGS. 9A-B are illustrations of graphical user interfaces for merchant cash flow management, according to an exemplary embodiment;

FIG. 10 is an illustration of a graphical user interface for analysis of offer performance on social media sites, according to an exemplary embodiment;

FIG. 11 is an illustration of a graphical user interface for managing merchant account information, according to an exemplary embodiment;

FIG. 12 is an illustration of a graphical user interface for a merchant homepage, according to an exemplary embodiment;

FIGS. 13A-E are illustrations of graphical user interfaces for merchant offer management, according to an exemplary embodiment;

FIG. 14 is an illustration of a graphical user interface for merchant offer redemption, according to an exemplary embodiment; and

FIG. 15 is a flow diagram of a process of a computerized system interaction with the merchant, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

Referring generally to the figures, computerized systems and methods for providing merchants with user interfaces for managing online deals are shown and described. The computerized system provides user interfaces to the merchant that allow the merchant to engage in self-service for the creation of deal offers and related marketing efforts. The computerized system includes components for managing multiple social media outlets in addition to a plurality of published deals or offers. The computerized system advantageously provides a single online resource for allowing a merchant to manage social media and online deal efforts. The merchant interface is advantageously available via mobile access as well as via web-based interfaces.

In one embodiment, the computerized system is configured to receive an input from a merchant via a merchant user interface that includes offers and offer information. The computerized system includes a business layer configured to use the offers and offer information to publish the offers, allowing users of the computerized system to bid on or purchase the offers. The offers may be published on a plurality of distribution channels. The business layer of the computerized system may further be configured to aggregate data relating to the published offers. The merchant may access the aggregated data via the merchant user interface and make adjustments to the offers. In other words, the computerized system is a self-service system that allows a merchant to provide, edit, analyze, and otherwise manage offers. The merchant may manage offers using the computerized system without a restriction based on the current status of the number of offers published, sold, or redeemed.

The computerized system may allow for merchants to provide offers in various ways. For example, the merchant may provide an offer for sale directly to the customer. As another example, the merchant may provide an offer for bidding (e.g., a customer may bid against other customers to win the offer (e.g., an auction), a customer may bid by himself/herself on the offer and be rewarded the offer if the bid is high enough, a group of customers may be presented with the offer (e.g., group buying), etc.). The transactions between the merchant and customer may be initiated in a variety of ways. For example, the merchant may provide an offer directly to a customer (e.g., one-to-one offer). As another example, the merchant may provide an offer to a group of customers either directly to the customers or by publishing the offer on a website or social media site (e.g., one-to-many offer). As another example, the merchant may provide a plurality of offers directly to a customer (e.g., a many-to-one offer). As another example, the merchant may provide a plurality of offers to a group of customers either directly to the customers or by publishing the offer on a website or social media site (e.g., many-to-many offer). As yet another example, the customer may search for published offers and submit a bid or purchase request to the computerized system and/or merchant.

The computerized system may allow merchants to provide contingency offers based on customer activity. For example, if a customer rejects or is not interested in an offer, the merchant may identify a contingency offer to provide the customer. The computerized system further identifies customers that merchants may be interested in marketing to and merchants that customers may be interested in purchasing offers from. The computerized system incorporates, aggregates, and creates various connections with third party sites (e.g., social media sites) that can be used to interact with the customers and the offers provided by the merchants.

Types of offers or products that may be provided by a merchant may include, for example, movie tickets, sporting tickets, restaurant discounts, spa gift cards, retail store discounts or gift cards, service discounts, gift cards, or vouchers for the goods or services listed above. In an exemplary embodiment, the computerized system tracks prior user browsing, searching, bidding, or other activities to determine which types of offers or products the user likely prefers. Such preferences may form the basis for the ordering or content of offers presented to any specific user. For example, an offer may only be available at certain times or certain locations, may be limited to a maximum number of customers, may be tiered, may be negotiable (e.g., the customer may bid on the offer), may be a combination offer (e.g., multiple offers sold as a single offer), or transferable (e.g., shared between multiple customers). The merchant as described in the present disclosure may be a business or one or more individuals that provide offers for purchase and use by a customer.

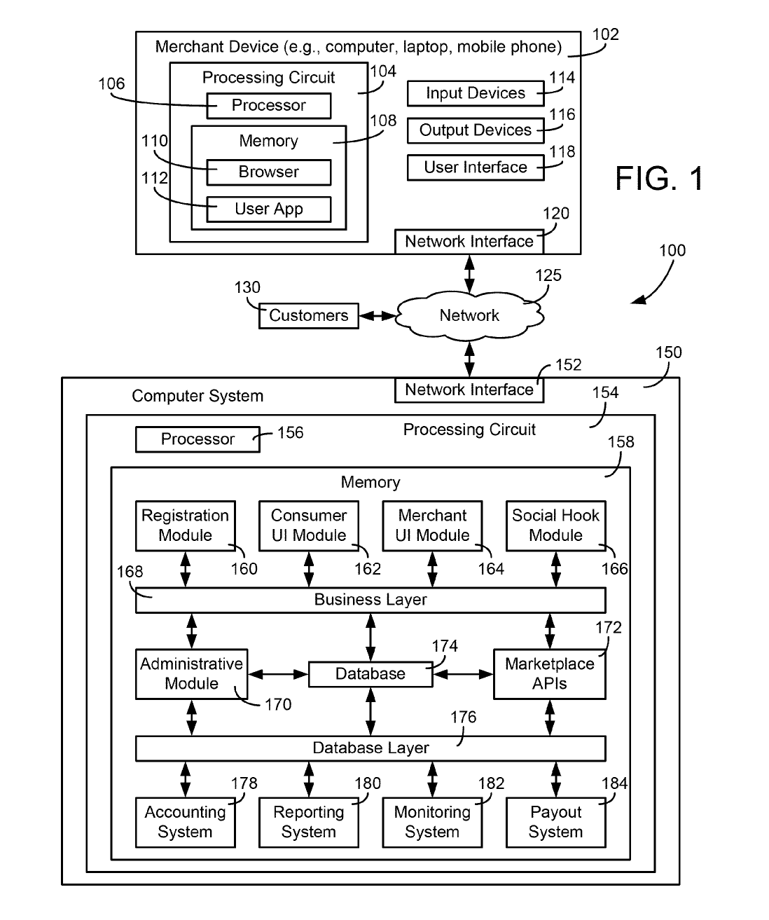

Referring to FIG. 1, a block diagram of a computerized system 100 for providing merchants with user interfaces for managing online deals is shown and described, according to an exemplary embodiment. System 100 includes a merchant device 102 (e.g., a computer, laptop, mobile phone, PDA, or other computing device operated by a merchant) for displaying the user interfaces for managing online deals. Marketplace computer system 150 provides data and user interface services to merchant device 102. For example, marketplace computer system 150 may include a web server for providing merchant-focused user interfaces to merchant device 102. The deals created and managed by the merchant via merchant device 102 and marketplace computer system 150 are offered to customers 130 (e.g., via a consumer-facing web page).

Merchant device 102 (e.g., mobile phone, laptop, etc.) may be used for submitting offers and making offer adjustments using merchant user interfaces served by marketplace computer system 150. Merchant device 102 includes a processing circuit 104, input and output devices 114 and 116, user interface 118, and network interface 120. Processing circuit 104 includes a processor 106 and memory 108 for completing the various merchant or client processes of the present disclosure. Processor 106 may be implemented as a general purpose processor, an application specific integrated circuit (ASIC), one or more field programmable gate arrays (FPGAs), a group of processing components, or other suitable electronic processing components. Memory 108 is one or more devices (e.g., RAM, ROM, flash memory, hard disk storage, etc.) for storing data and/or computer code for completing and/or facilitating the various user or client processes, layers, and modules described in the present disclosure. Memory 108 may be or include volatile memory or non-volatile memory. Memory 108 may include database components, object code components, script components, or any other type of information structure for supporting the various activities and information structures of the present disclosure. Memory 108 is communicably connected to processor 106 and includes computer code or instruction modules for executing one or more processes described herein.

Memory 108 is shown to include a browser module 110 and a user app module 112. Browser module 110 is configured to provide a software application for viewing a merchant interface on system 100. Browser module 110 may be used when the merchant is accessing system 100 on a laptop, desktop, or a mobile device that does not have or support a particular application for interfacing with system 100. On some devices (e.g., general purpose computers), merchant device 102 is simply a computer with a web browser and the merchant uses the web browser to receive merchant user interfaces from marketplace computer system 150.

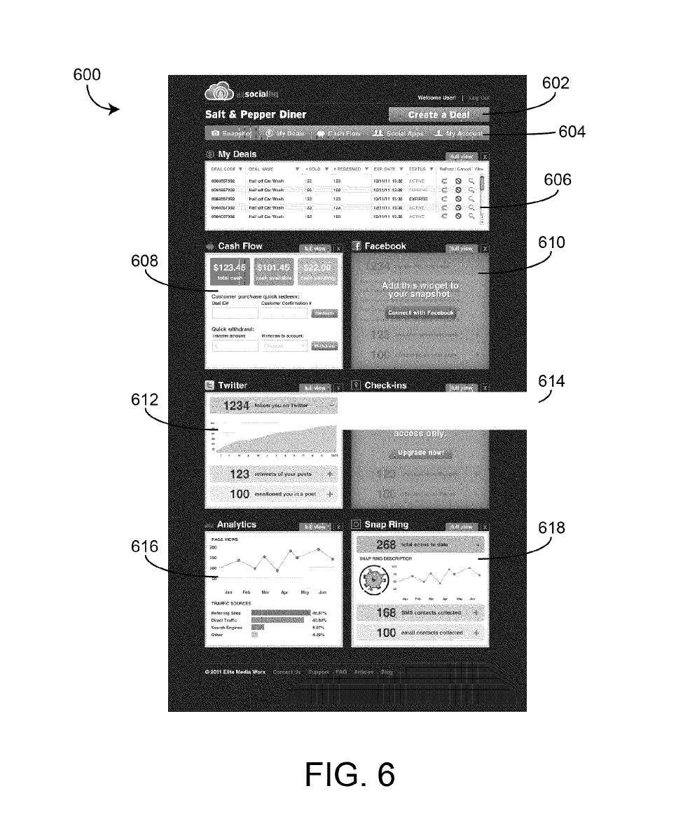

In embodiments where merchant device 102 is a handheld device or mobile phone (e.g., without a full web browser), a standalone application or ‘user app’ may be installed on the merchant device 102 for assisting with the display of merchant user interfaces. User app module 112, for example, may be configured to provide such an application. Where user app module 112 is used, many of the resources for providing the merchant user interfaces may be stored on the merchant device 102 and the back-end data may be received from marketplace computer system 150. The user interfaces of FIGS. 6-11 are examples of applications provided by a browser module 110 and the user interfaces shown in FIGS. 12-14 are examples of applications provided by user app module 112. In some embodiments, elements of the screenshots of FIGS. 6-11 and FIGS. 12-14 may be shown on either type of client (e.g., a browser-based client or an application-based client) without departing from the scope of the present disclosure.

Merchant device 102 further includes network interface 120 which is configured to communicate with marketplace computer system 150 via network 125 (e.g., a mobile phone network, the Internet, a combination thereof, etc.). Input devices 114 may include any input device (e.g., keyboard, mouse, phone keypad, touchscreen, etc.) that may be used by a merchant to submit offers and offer information. Output devices 116 may include display screens, monitors, speakers, and/or other visual and audio components for providing a user of device 102 with offer information (e.g., offer information aggregated by marketplace computer system 150). User interface 118 can be any control, pointer, keypad, or sensor configured to accept user input. It should be appreciated that some merchant devices 102 (e.g., full computers) will include many input devices 114, output devices 116, or user interfaces 118 while other merchant devices 102 (e.g., a touchscreen-based mobile phone) will primarily have a single touchscreen display for all user input/output activities.

Marketplace computer system 150 is configured to receive offer information from a merchant via merchant device 102 and network 125. Marketplace computer system 150 receives bids and purchase orders from multiple customers 130 that connect to marketplace computer system 150 via network 125. Marketplace computer system 150 further provides merchant device 102 with information relating to the selling and performance of the merchant offers, and allows the merchant to redeem the offers. Marketplace computer system 150 includes network interface 152 which is configured to communicate with merchant device 102 via a network or networks 125 (e.g., a mobile phone network, the Internet, etc.).

Marketplace computer system 150 includes a processing circuit 154 including a processor 156 and memory 158. Processor 156 may be implemented as a general purpose processor, an application specific integrated circuit (ASIC), one or more field programmable gate arrays (FPGAs), a group of processing components, or other suitable electronic processing components. Memory 158 is one or more devices (e.g., RAM, ROM, Flash memory, hard disk storage, etc.) for storing data and/or computer code for completing and/or facilitating the various user or client processes, layers, and modules described in the present disclosure. Memory 158 may be or include volatile memory or non-volatile memory. Memory 158 may include database components, object code components, script components, or any other type of information structure for supporting the various activities and information structures of the present disclosure. Memory 158 is communicably connected to processor 156 and includes computer code or instruction modules for executing one or more processes described herein.

Memory 158 includes various modules for completing the processes described herein. Memory 158 includes a registration module 160 configured to allow merchants to register with computerized system 100. Registration of a merchant may include receiving merchant information (e.g., business name, address, contact information, account information, etc.). Upon registration, the merchant may be allowed to use merchant user interfaces (e.g., served by marketplace computer system 150, generated by a user app 112 in combination with data from marketplace computer system 150) to create offers and to manage offers (e.g., conduct self-service offer creation and management).

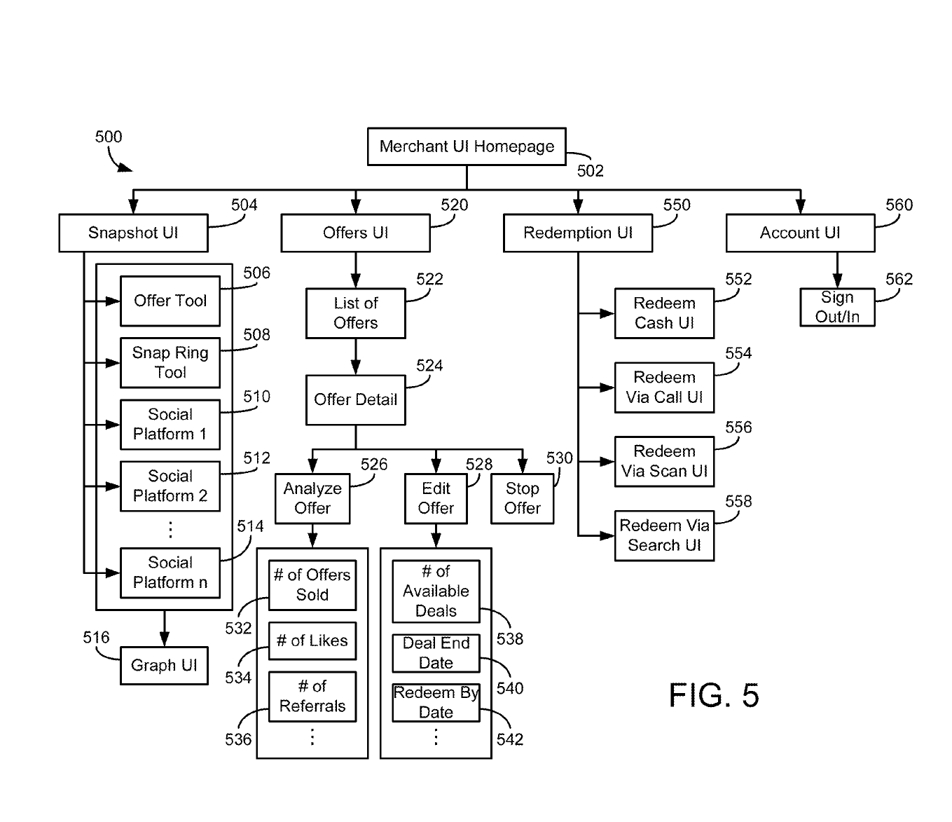

Memory 158 further includes a customer user interface (UI) module 162 and merchant UI module 164. Merchant UI module 164 is shown in greater detail with reference to FIGS. 5-14. Customer UI module 162 is configured to provide user interfaces to end users for viewing and purchasing offers created by the merchants. For example, customer UI module 162 may provide an interface that allows a customer to bid on an offer. Marketplace computer system 150 may receive the bid and determine if the bid should be accepted or denied, or whether the bid should be evaluated later if the bid is part of an auction. Marketplace computer system 150 may restrict the number of bids a customer is allowed, or may otherwise restrict customer access to marketplace computer system 150 via customer UI module 162. As another example of a customer user interface that may be provided by customer UI module 162, customer UI module 162 may provide an interface that allows a customer to specify a budget (e.g., a desired amount the customer is willing to spend), and marketplace computer system 150 may then provide the customer with relevant offers based on the budget (or other customer preferences such as type of offer). Particular examples of such customer-facing user interfaces (e.g., bidding user interfaces) and related systems and methods are shown and described in U.S. application Ser. No. 13/187,431 and U.S. application Ser. No. 13/187,432, both filed Jul. 20, 2011 and entitled COMPUTERIZED SYSTEM AND METHOD FOR PRESENTING DISCOUNT OFFERS, both of which are incorporated by reference in their entireties.

Memory 158 further includes a social hook module 166 configured to send and receive information from social media sites. For example, social hook module 166 may be configured to manage the social media advertisement, promotion, or other ‘social hooks’ of offers made available by the merchant via the marketplace computer system 150. Further, social hook module 166 may receive input from a social media site when a customer interacts with the offer (e.g., views the offer, clicks on the offer, submits a bid or purchase order on the offer, etc.) via social media. Social hook module 166 may advantageously allow the merchant to view statistics (graphs, summaries, etc.) relating to social media promotional efforts.

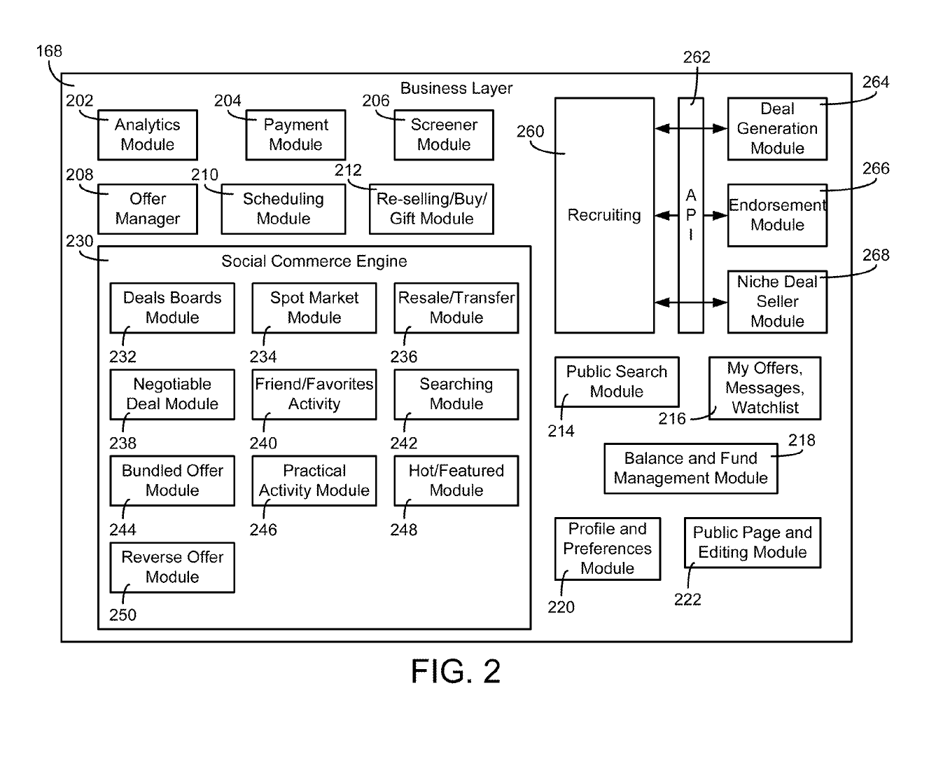

Memory 158 includes a business layer 168 connected to modules 160-166. Business layer 168 receives information from modules 160-166 relating to merchant information, customer information, and social media information. For example, business layer 168 receives data mentioned above relating to the registration module 160, consumer UI module 162, merchant UI module 164, or social hook module 166. Business layer 168 uses the received information to manage transactions, manage merchant use of marketplace computer system 150, and to handle interaction between outside sources (e.g., customers) connecting to marketplace computer system 150 via network 125. Business layer 168 can store received information in database 174 or recall information from database 174. Business layer 168 is shown in greater detail in FIG. 2.

Business layer 168 is further connected to administrative module 170. Administrative module 170 is configured to provide user interfaces to an administrator of marketplace computer system 150. Administrative module 170 may be used by the administrator to, e.g., manage merchant permissions and accessibility.

Business layer 168 is further connected to marketplace application programming interfaces (APIs) 172. Marketplace APIs 172 can allow new or third party applications, ‘apps’ or websites to interact with marketplace computer system 150 via interfaces other than those provided by modules 160-166.

Memory 158 includes a database 174 configured to store offer, deal, bid, redemption, merchant, social media, and customer information. Database 174 can also store relationships between information and any other data necessary to facilitate the systems and methods described herein. The stored offer information may include, for example, whether the offer has been sold or not, the quantity of offers sold, the expiration date or other date information specifying when and how to publish the offer, where the offer has been published, details of customer interaction with the offer, and any other type of offer information. The merchant information may include merchant profile information (e.g., name, account information, contact information, etc.) and offer information (e.g., current active and inactive offers the merchant has submitted to marketplace computer system 150, the purchase price of the offer, etc.). The customer information may include, for example, account information. Account information of the users may include the name of the user, address of the user, phone number or other contact information (e.g., e-mail) of the user, payment information (e.g., credit card information or online account information) of the user, user verification information (e.g., a password associated with the user account), user preference information, or other user information. The account information may be used to register or subscribe a customer to computerized system 100. The account information may be used to validate user credentials or user information and help process transactions for system 100 (e.g., when a user places a bid on an offer or purchases an offer, account information may be used to verify the bid or purchase before completing the order). Account information may further include any rewards, discounts, or other incentives related to a particular customer. Account information may further include account activity or history information (e.g., date of last login, number of purchases, detail regarding previous purchases, etc.). Such activity or history information may be used to determine whether the user is a frequent bidder or purchaser, or to conduct other analytics or to make other conclusions. Marketplace computer system 150 may use such information to provide customized offers, discounts, or rewards to the user. Account information may further include customer bid information (e.g., the customers submitting the bids, the bid value, the timestamps of the bids, quantity information, etc.).

Memory 158 includes a database layer 176 connected to database 174. Database layer 176 can manage database 174 and can facilitate connections to other databases of the marketplace owner (e.g., an accounting system 178, a reporting system 180, a monitoring system 182, a payout system 184, etc.). While database 174 is shown as logically above and separate from database layer 176, it should be appreciated that database 174 can alternatively be integrated within or logically below database layer 176.

Accounting system 178 may be configured to facilitate automated accounting logging for the marketplace owner. For example, when a merchant authorizes an offer for publishing, marketplace computer system 150 may charge the merchant for publishing the offer. Accounting system 178 can log the transaction via its connection to the marketplace components of marketplace computer system 150.

Memory 158 includes a reporting system 180 configured to generate reports for a merchant. The reports generated by reporting system 180 may provide information relating to offer performance, social media activity, or other trends or data relating to the publishing and sale of merchant offers. For example, reporting system 180 may generate a report for a particular offer (e.g., showing how many times the offer has been purchased, the number of views or clicks on the offer, the number of times the offer was shared via a social media site, etc.) or for all offers provided by a merchant (e.g., all offers published on a particular social media site or across all social media sites). The report may be in the form of a graph, a list of offer information, or any other format. An example report reporting system 180 can generate is shown in greater detail in FIG. 10.

Memory 158 includes a monitoring system 182 configured to monitor merchant offers. The information gathered by monitoring system 182 may then be provided to reporting system 180 for generating a report, to the merchant via merchant device 102, to database 174 for storage, or to another system of marketplace computer system 150.

Memory 158 includes a payout system 184 configured to manage payments to merchants, consumers or other agents.

The various systems and modules shown as part of marketplace computer system 150 may be connected to business layer 168, and work with modules of business layer 168 to complete the systems and methods described herein. For example, business layer 168 may include a payment module, and payout system 184 may use information from the payment module to manage payments to the merchant. As another example, business layer 168 may include various modules receiving offer performance information, and reporting system 180 may use the offer performance information to generate reports.

Referring now to FIG. 2, business layer 168 is shown in greater detail. Business layer 168 is configured to receive offers and offer information from a merchant (e.g., via the merchant UI module 164 shown in FIG. 1) and to publish the offers (e.g., to a consumer via consumer UI module 162 shown in FIG. 1). Further, business layer 168 is configured to aggregate data relating to the published offers and to provide the data to the merchant for analysis and offer adjustments. By aggregating data, facilitating the creation of offers via the merchant UIs, allowing the management of offers, and allowing the management of tools (e.g., social media outlets) for promoting the offers, business layer 168 advantageously helps merchants use marketplace computer system 150 as a self-service system (e.g., an integrated system in which the merchant may manage his/her online deals and marketing without the assistance of other personnel).

FIG. 2 illustrates modules of business layer 168 that provide or facilitate the activities described herein. For example, business layer 168 is shown to include an analytics module 202 configured to analyze a merchant's information (e.g., offer performance, marketing performance, return on investment, etc.) and to provide results of the analyzed performance to other modules (e.g., the merchant UI, a reporting system, an accounting system, other modules shown in FIG. 1, etc.). Analytics module 202 may highlight important aspects of offer performance as it relates to the merchant and merchant's choices.

Business layer 168 includes a payment module 204 configured to manage payment of the offers. For example, when a customer purchases an offer, payment module 204 is configured to cause a corresponding payment to be made to a merchant account (e.g., the purchase price minus fees to the owner of the marketplace computer system). Payment module 204 may further be configured to manage voucher redemption (e.g., the customer may receive a voucher for the offer upon purchase of the offer, and payment module 204 may facilitate a voucher tracking and redemption process).

Business layer 168 includes a screener module 206 configured for use in screening offers provided by the merchant. The screening of offers may be used by business layer 168 to determine an ideal schedule, website or social networking site, or other option for publishing the offer. The screening of offers may also be used to help determine if any of the offers created by the merchant violate a marketplace or site policy.

Business layer 168 includes an offer manager 208 configured to allow the management of offers and their publishing details via a merchant UI. For example, offer manager 208 may be configured to provide the offer for publishing on a website when the schedule of the offer indicates that it is time to publish the offer. Offer manager 208 can provide user interface tools to the merchant UI for allowing the merchant to adjust a duration for an offer, a number of offer acceptances, whether the offer is published on the web and via mobile sources, a scaling price system relating to the offer, or other parameters for publishing the offer. Further, offer manager may provide user interface tools to the merchant UI that allows the merchant to change display traits of the offer on a website, how the offer is to be redeemed via the computerized system, etc.

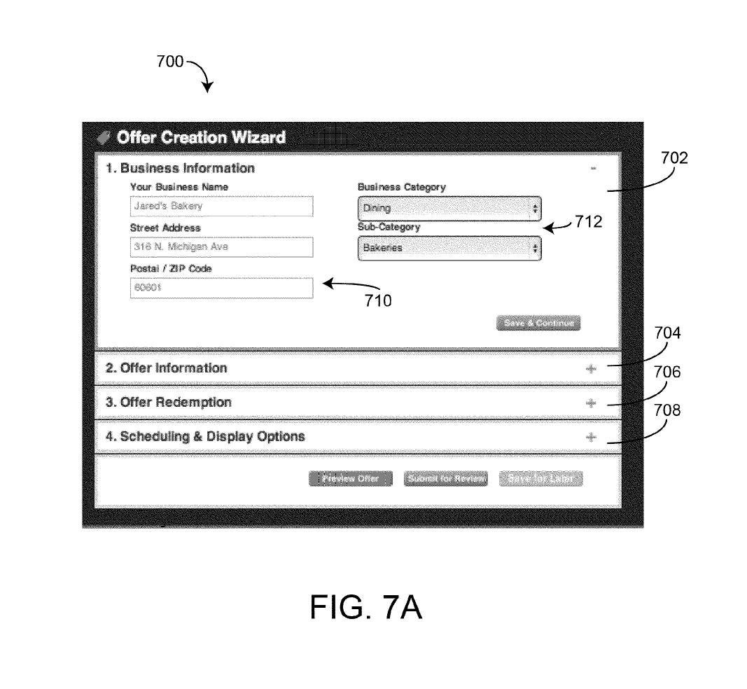

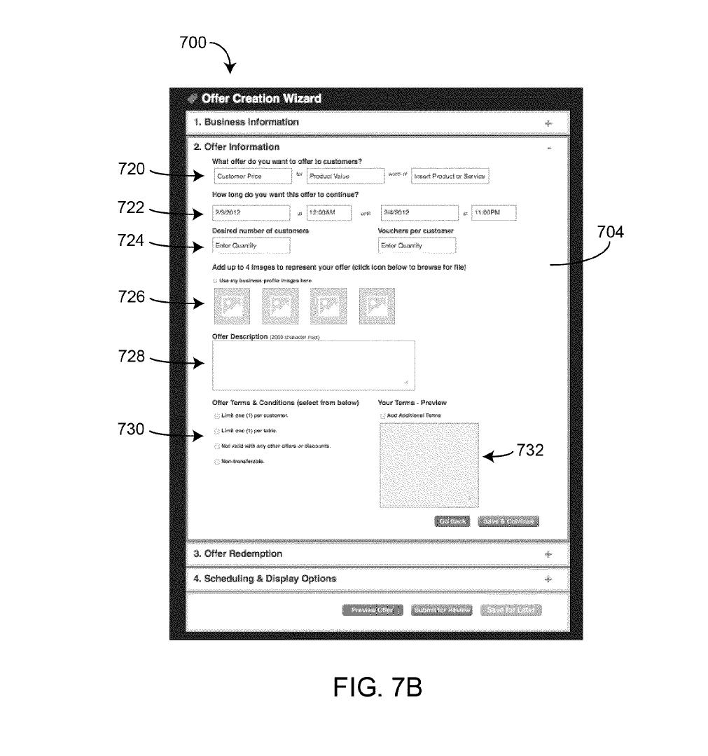

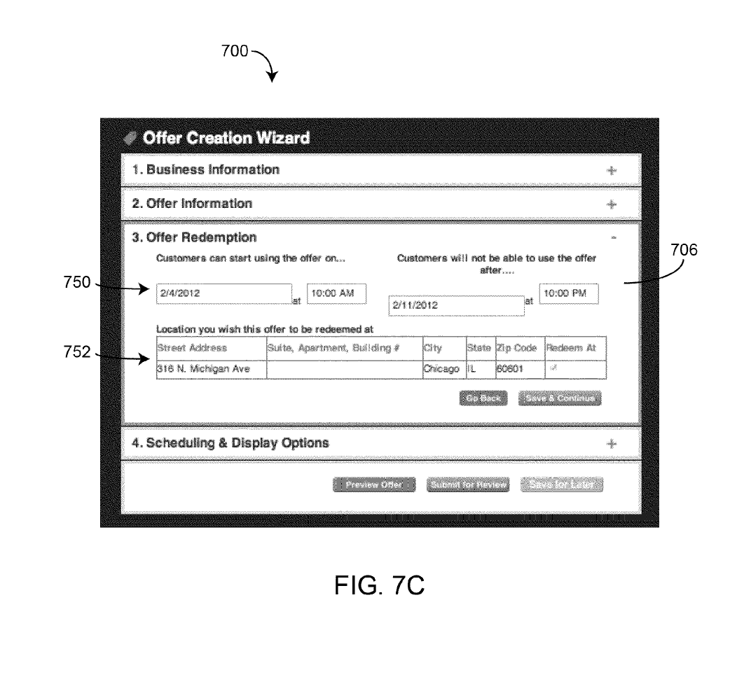

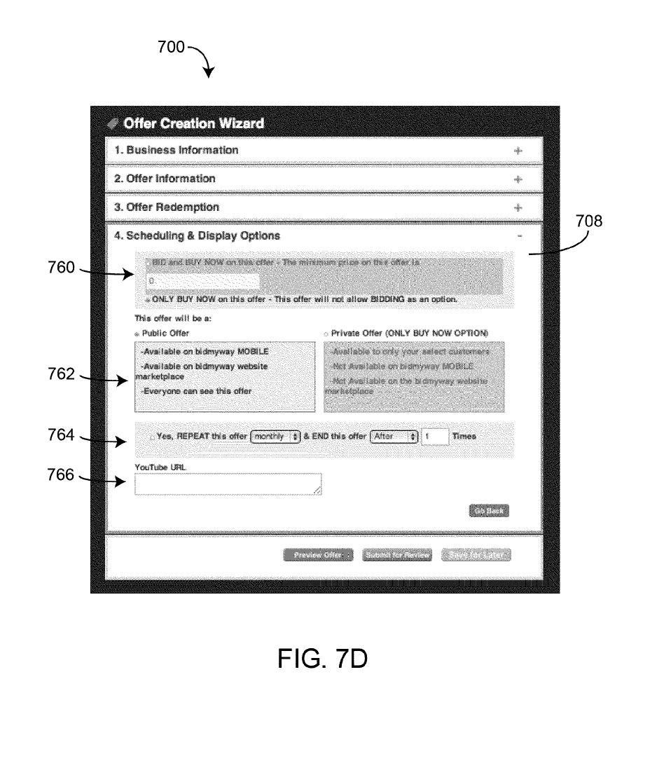

Business layer 168 includes a scheduling module 210 configured to manage offer schedules and to allow a merchant to adjust schedules via a merchant UI. Each offer to be published may be related to a schedule of when the offer is to be published. The schedule may indicate when an offer is first to be published, when an offer is to be rescinded, when an auction or bidding window should end, how often to publish the offer on a given website or other site, or any other schedule details that relate to how and when to publish the offer and provide the offer for purchase. An example of a user interface for managing scheduling information is are shown in FIG. 7D.

Business layer 168 includes a re-selling/buy/gift module 212 configured to allow merchants to adjust settings relating to reselling, trading, gifting, or otherwise exchanging offers/vouchers outside of the normal buy/bid channel. For example, a customer may wish to resell an offer upon purchase. Module 212 may be configured to provide the offer for resale at a price the customer specifies. If the offer is then resold, module 212 may be configured to distribute the profit of the sale between the computer system, merchant, and customer. For example, if the customer purchases an offer at $200, and chooses to resell the offer at $230, the offer may then be sold to another customer at $230. The profit of $30 may then be split among the computer system, merchant, and customer.

As another example, a merchant may choose to allow reselling offers if a customer or group of customers that initially purchased the offer is unable to redeem the offer. Allowing such reselling may reduce the number of ‘dead’ purchases that do not actually drive traffic to the merchant. Module 212 may then be configured to republish the offer on consumer user interfaces (e.g., mobile, web, social media, etc.). As another example, if the merchant indicates that an offer is eligible to be provided as a gift to a customer, module 212 may be configured to provide user interface tools (e.g., to a merchant UI, to a consumer UI, etc.) for completing such a transfer. As yet another example, if the customer indicates that a purchased offer is to be provided to another user as a gift, module 212 may be configured to receive user information from the customer via a customer UI and to provide the recipient of the gift with the offer and offer information. The customer may indicate that the offer is intended to be a gift for another user before or after purchase of the offer.

Business layer 168 includes a public search module 214. Public search module 214 may categorize or index offers for searching on merchant UIs or consumer UIs. Public search module may be configured to use keywords or tags associated with the offers to index and categorize the offers.

Business layer 168 includes a module 216 that includes offers, messages, and watchlists for use by merchants on a merchant UI. Business layer 168 further includes a public page and editing module 222. Public page and editing module 222 can provide user interface tools on a merchant UI for allowing the merchant to configure a public page for the merchant and to edit the public page once created. The public page may be one distribution channel for publishing offers of a created deal or for otherwise promoting the merchant.

Business layer 168 includes a balance and fund management module 218 configured to manage merchant revenue related to the offers and customer accounts. Balance and fund management module 218 may be configured to manage a merchant account. For example, when a merchant provides an offer to business layer 168 for publishing, balance and fund management module 218 may determine a cost of publishing and displaying the offer. Balance and fund management module 218 may be configured to deduct from the merchant account the cost of publishing and displaying the offer. Further, balance and fund management module 218 may credit a merchant account when an offer is purchased and/or redeemed by a customer. Balance and fund management module 218 may further provide an indication to the merchant of which offers resulted in how much revenue. In other words, balance and fund management module 218 tracks funds for the merchant. Further, balance and fund management module 218 may also track customer funds.

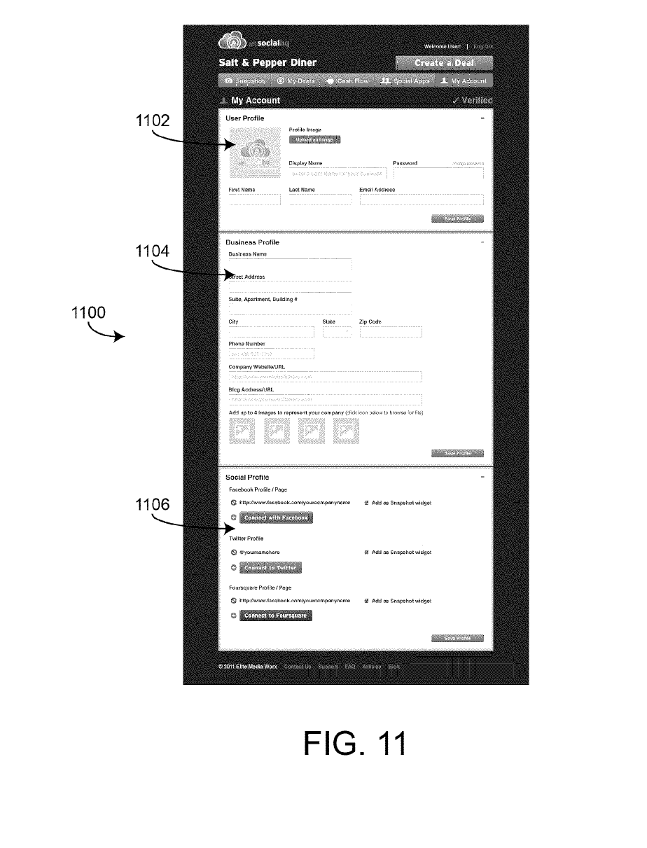

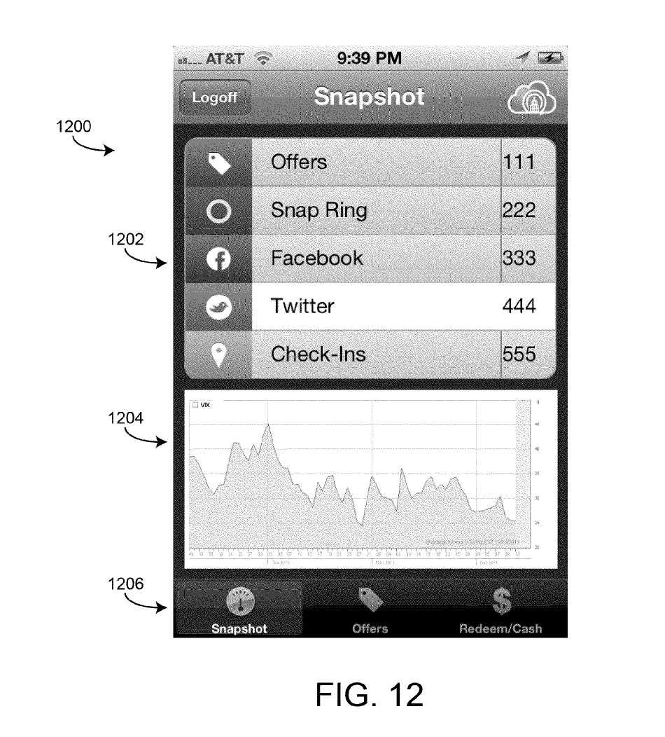

Business layer 168 includes a profile and preferences module 220 configured to store merchant profiles and preferences received from a merchant UI. For example, a merchant may provide a merchant profile to business layer 168. The merchant profile may include information about the merchant (e.g., a business name, location, description, a business profile, etc.), the types of offers (e.g., products and services) provided by the merchant, contact information (e.g., e-mail address, phone number, address, etc.), social media preferences, and other basic information about the merchant. Merchant preferences may include a general strategy for presenting offers to customers (e.g., a general schedule, display preferences when the offer is published, etc.). Merchant profile and preference information is described in greater detail with reference to FIG. 11.

Business layer 168 includes a social commerce engine 230 configured to manage offers to be provided on websites. Social commerce engine 230 includes various modules configured to manage offers and offer publishing on one or more sites.

Social commerce engine 230 includes a deals boards module 232 configured to provide the merchant UI with a tool for managing a merchant's deals board. The deals board may be a listing of hot or recent deals associated with the merchant. The deals board may be published on the merchant's public page, a social networking site, or in other online outlets associated with the merchant. A UI tool provided by deals board module 232 may allow, for example, the merchant to add, delete or reorder deals on the board.

Social commerce engine 230 includes a spot market module 234 configured to provide a user interface tool to the merchant UI for creating short-term offers. For example, if the merchant determines that an offer can be provided in response to a short-term spike in demand for the offer, the merchant may provide the offer and offer information to spot market module 234. Spot market module 234 may then be configured to publish the offer and to allow the merchant to manage the offer based on short-term demand of the offer. For example, for an offer for tickets to an event occurring in 24 hours, spot market module 234 may be configured to increase visibility of the offer and to provide analysis of offer performance based on very recent activity compared to long-term activity.

Social commerce engine 230 includes a resale/transfer module 236 configured to allow a merchant or customer to re-sell a failed offer or transfer an offer to another customer. Module 236 is configured as described with reference to module 212. Module 236 may be configured to provide a user interface tool to the merchant UI or customer UI that allows the merchant to determine offer display preferences for the transfer or resale.

Social commerce engine 230 includes a negotiable deal module 238 configured to allow a merchant and customer to negotiate the terms of an offer. For example, the merchant may provide an offer via a merchant UI and indicate that the offer may be bid on or negotiated. The customer may then submit a bid on the offer and negotiable deal module 238 may determine whether to accept or deny the bid based on merchant preferences. For example, the merchant may specify that if an offer does not sell by a given date, then the minimum purchase price the merchant is willing to accept for the offer may be lowered by a set amount.

Social commerce engine 230 includes a friend/favorites activity module 240 configured to provide a user interface tool to the merchant UI that allows a merchant to view customer activity with regards to sharing offers with friends and favoriting the offer. For example, the customer may choose to “like” the offer on Facebook, retweet a link to the offer on Twitter, share the offer with friends on Facebook, etc.

Social commerce engine 230 includes a searching module 242 configured to provide a user interface tool to the merchant UI that allows a merchant to search for an offer or view what customers are searching. The customers may search for offers based on offer type (e.g., a category or sub-category of the offer as determined by the merchant), an offer expiration date, price, or any other parameter.

Social commerce engine 230 includes a bundled offer module 244 configured to provide a user interface tool to the merchant UI that allows a merchant to bundle offers together and provide the bundled offers as a single offer. For example, the merchant may bundle two offers together and have the new offer published. The merchant may choose to bundle offers if an offer is not selling in order to improve sales, or if the offers are related. For example, the merchant may bundle two offers for activities that are related and offer a discounted price for the bundled offer compared to if a customer purchased the two offers separately. In one embodiment, the merchant may create a bundled offer for a customer in response to a customer preference or suggestion.

Social commerce engine 230 includes a practical activity module 246 configured to provide a user interface tool to a merchant UI that allows a merchant to view a measure of aggregate activity across multiple social media and/or deal publishing platforms.

Social commerce engine 230 includes a hot/featured module 248 configured to provide a user interface tool to a merchant UI that allows a merchant to view or select offers to be featured by the computerized system or to view offers that are “hot” (e.g., offers performing well). For example, for an extra fee, the merchant can choose to make a provided offer “featured”, which allows the offer to be featured more prominently or frequently on a webpage or social networking site. As another example, the merchant can see which offers are selling out or doing well compared to other offers from the merchant or other merchants.

Social commerce engine 230 includes a reverse offer module 250 configured to provide a user interface tool to a merchant UI that allows a merchant to use a reverse offer process to sell an offer to a customer. For example, if the customer indicates interest in an offer, the merchant may make an offer to the customer (e.g., a purchase price) that the customer can accept or deny.

Business layer 168 further includes a recruiting module 260 connected to a deal generation module 264, endorsement module 266, and niche deal seller module 268 via API 262. Deal generation module 264 allows merchants to provide offers to business layer 168.

Niche deal seller module 268 provides a user interface tool to a customer that allows the user (e.g., a customer, business, publisher of a website, etc.) to receive offers to be published and to re-sell the offers. For example, a user may build an application to re-sell a purchased offer, and the user may receive a small commission from the computer system or merchant upon re-selling the offer. The process of re-selling offers is described in greater detail with reference to module 212. Niche deal seller module 268 may be configured to publish the offers to a website or social networking site. For example, the user may choose to post the offer in a Twitter post, an iPhone application, Facebook page, etc. The offer may be posted based on one or more time periods (e.g., on a weekend, holiday, or other significant period of time that the offer may be of special interest, a time period specified by the user, etc.).

Business layer 168 may further be configured to manage or provide customer lists for the merchant. Business layer 168 (and/or another module of marketplace computer system 150) may be configured to create customer lists (e.g., prospective customer lists) based on customer trends, information, or other properties (e.g., location). For example, business layer 168 may have a list of all customers that appear to be interested in a certain product (e.g., a particular restaurant or sports team). As another example, all customers who previously purchased an offer from a particular merchant may be put into a list or all customers living in a particular area may be put into a list. Business layer 168 may then be configured to provide a user interface tool to the merchant UI that allows the merchant to view the lists and to select one or more lists for use in publishing a defined deal as an offer to everyone on the list (e.g., via a bulk e-mailing service). The merchant UI and the business layer may cause the merchant to be charged for access to customer lists and for publishing offers of defined deals to the contacts on the customer lists. When instructed by inputs received at the merchant UI, the business layer may cause the offers to be published to the users of the selected lists, allowing the merchant to target a specific audience that may be interested in an offer.

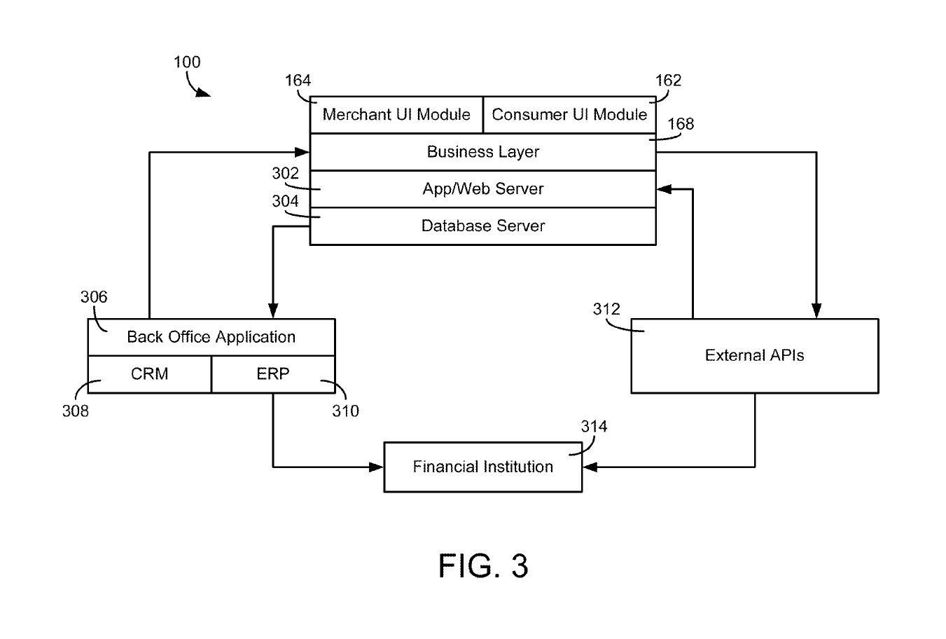

Referring now to FIG. 3, an architecture block diagram of computerized system 100 is shown, according to an exemplary embodiment. Business layer 168 is communicably connected to merchant UI module 164 and consumer UI module 162 as described in FIG. 1 or otherwise (e.g., over a remote link). Business layer is further connected to application/web server 302 and database server 304.

Computerized system 100 includes a back office application 306 communicably connected to business layer 168. Back office application 306 is configured to receive offers from business layer 168 for publishing. Computerized system 100 further includes a customer relationship management (CRM) module 308 configured to manage or assist with management of customer and merchant interaction. Computer system 100 further includes enterprise resource planning (ERP) module 310 configured to integrate information between the various systems of computerized system 100. A financial institution 314 (e.g., a bank), may be communicably coupled to layers or modules of the computerized system 100, and the various modules and systems of system 100 may be in communication with financial institution 314 during offer redemption and purchase (e.g., managing customer and merchant accounts).

Computerized system 100 includes external APIs 312 communicably connected to business layer 168 and application/web server 302. APIs 312 manage the interaction between computerized system 100 and external sites at which offers may be published. For example, external APIs 312 may be configured to manage interactions between social networking sites (e.g., Facebook, Twitter, etc.) and computerized system 100. As another example, APIs 312 may be configured to manage interactions with payment processing services (e.g., Paypal, Google checkout, etc). As another example, APIs 312 may be configured to manage interactions with various other services (e.g., mobile applications, reseller applications, etc.).

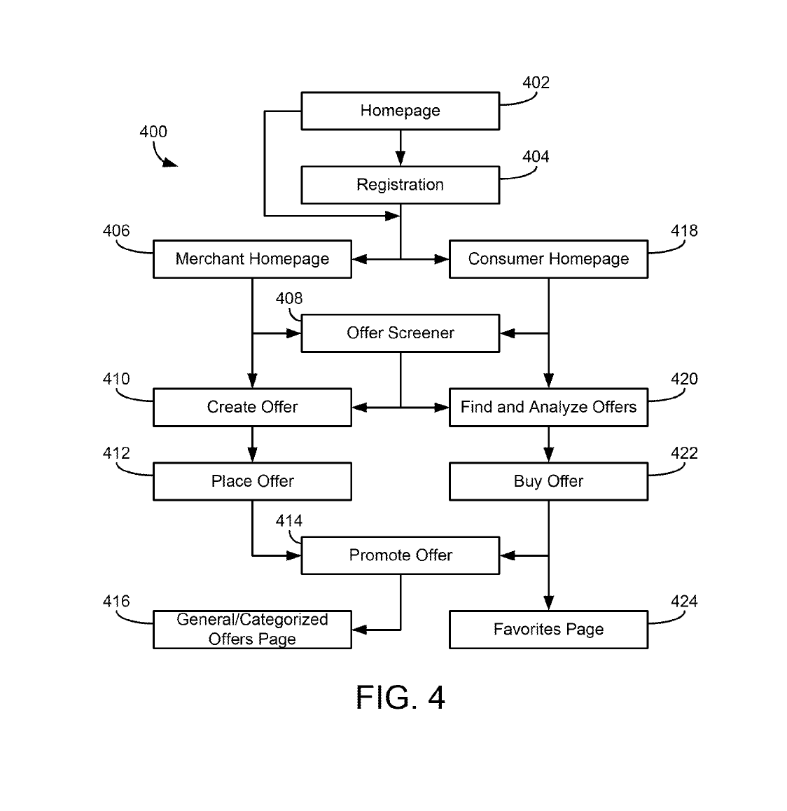

Referring to FIG. 4, a flow chart of a process 400 of merchant and consumer usage computerized system 100 is shown, according to an exemplary embodiment. The merchant or consumer may start at a homepage of the computerized system (step 402). The homepage may allow a customer or merchant to sign into the system, view featured offers, offers ending soon, new offers, or other special deals, may include general account information for the customer or merchant, or any other general information relevant to the customer or merchant. If the merchant or customer is not registered with the system, the system may register the merchant or consumer (step 404). Registration may include receiving and storing merchant or consumer information, and may be managed by, for example, registration module 160. Merchants are then taken to a merchant homepage (e.g., merchant UI provided by a merchant UI module and populated with information gathered by the business layer) (step 406) and consumers to a consumer homepage (step 418). The merchant homepage may include profile settings, preferences, active offers, analytics, and any other general information relevant to the merchant. The customer homepage may include a list of offers, preferences, profile settings, relevant offers, and any other general information relevant to the customer.

At the merchant homepage (e.g., merchant UI), the merchant may screen for offers (step 408) and create an offer (step 410). Creating the offer may include defining the parameters of a deal and determining which publication channels to offer the deal upon. In another embodiment, the merchant may create an offer at step 410 without screening for offers at step 408. Screening for offers may include seeing existing offers published by the merchant or by another merchant. The screener tool at step 408 may allow a merchant (or a customer) to screen offers based on keywords, offer activity, location, time, when the offer is ending, the market the offer is tailored to, or other offer properties. Creating the offer may include setting up terms of the offer (such as purchase price, expiration date, the number of offers available, a location or time the offer is to be redeemed, or other contingency information), adding tags or keywords to the offer (e.g., terms that allow the offer to be searched for by a customer entering the tag or keyword), providing a category or sub-category that classifies the offer, or conducting other tasks that define a deal/offer.

After defining or creating an offer, the merchant may place the offer (step 412) (e.g., publishing the offer) and promote the offer (step 414). Publishing and promoting the offer may include determining which sites to post the offer on or if the offer is to be e-mailed or otherwise delivered to potential customers. For example, offer publishing and promotion may include posting the offer on a social media site, e-mailing the offer, or providing details about the offer to agents or resellers. The merchant, upon publishing and promoting the offer, may be taken to a general or categorized offers page (step 416). The offers page may provide the merchant with various information relating to the merchant offers (e.g., the status of the offers, current statistics of offer performance, revenue generated by the offers, etc.).

The customer homepage may include a list of offers that may be relevant to the customer. For example, the list of offers may be tailored to the customer's history (e.g., previous purchases or bids). The customer homepage may further include various fields for changing or updating profile settings, for posting offers and offer information on social media sites, or other general customer activity. At the customer homepage, the customer may screen for offers (step 408) and find and analyze offers (step 420). Screening for offers at step 408 may include searching for offers (e.g., searching by type of offer, by merchant, by price, by offer category, etc.). If the customer finds an offer he/she wishes to purchase or bid on, the customer may buy (or bid on) the offer (step 422). The customer may further choose to promote the offer (step 414). The offer promotion may include the customer sharing the offer with other customers or friends, posting offer details or offer purchase details on a social media site, etc. The customer may then access a favorites page (step 424) or an offers page (step 416) where the customer may view his/her purchases, preferences, or other offer information. For example, on the favorites page, the customer may endorse the offer or the merchant providing the offer just purchased on a public profile page of the customer (either on a website or on a social media site).

Step 422 of buying an offer may include various sub-steps. In one embodiment, step 422 may include a negotiation process in which the customer can negotiate with the merchant or computer system for the offer. For example, the customer may enter a bid for the offer, and the computer system may use merchant preferences to determine whether to accept the bid or not. In another embodiment, step 422 may include participation in an auction for an offer.

Referring now to FIG. 5, a flow chart of a process 500 for merchant interaction with computerized system 100 is shown, according to an exemplary embodiment. Process 500 begins at a merchant UI homepage (step 502) where a merchant may access various user interfaces for managing, analyzing, and redeeming offers.

The merchant may choose to view the snapshot UI (step 504) (e.g., provided by the merchant UI module). The snapshot UI may be a user interface configured to provide the merchant with a display of data relating to the offers and offer performance. For example, from the snapshot UI, the merchant may access an offer tool (step 506). The offer tool may be a user interface that allows a merchant to view all merchant offers currently being published, along with the status of the offers, the number of offers sold, and other offer and merchant information.

From the snapshot UI, the merchant may access a snap ring tool or other image recognition-based tool (step 508). The snap ring tool may be a user interface that allows a merchant to track snap ring scans related to offers. In other examples, the merchant may scan a quick response (QR) code or bar code of a voucher redeemed by a customer, and the computerized system may track the scans. The snap ring tool is shown in greater detail in window 618 of FIG. 6.

From the snapshot UI, the merchant may access tools for various social platforms (steps 510, 512, 514). For example, a tool for each type of social media site an offer can be published on may be provided to the merchant. Examples of various types of social media site tools are shown in windows 610-612 of FIG. 6.

After the merchant accesses one or more tools at steps 506-514, the merchant may request a graph (or other type of report or output) that includes data regarding offers and offer performance. The merchant may access a graph UI (step 516). An example graph UI is shown in FIG. 10.

The merchant may choose to view the offers UI (step 520). At the offers UI, the merchant may view a list of offers (step 522) and offer details for each offer (step 524). The list of offers may be all offers provided to marketplace computer system 150 by the merchant, according to an exemplary embodiment. The offer list and offer details are shown in greater detail in window 606 of FIG. 6.

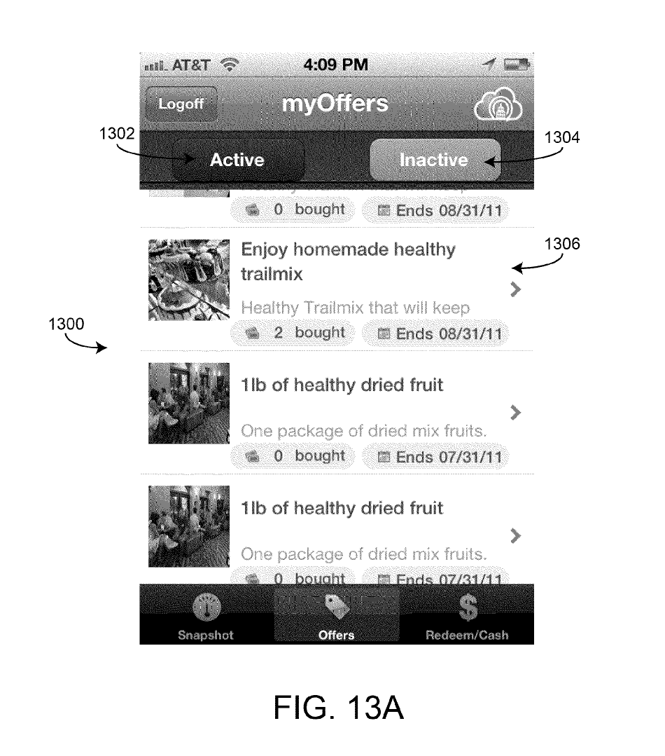

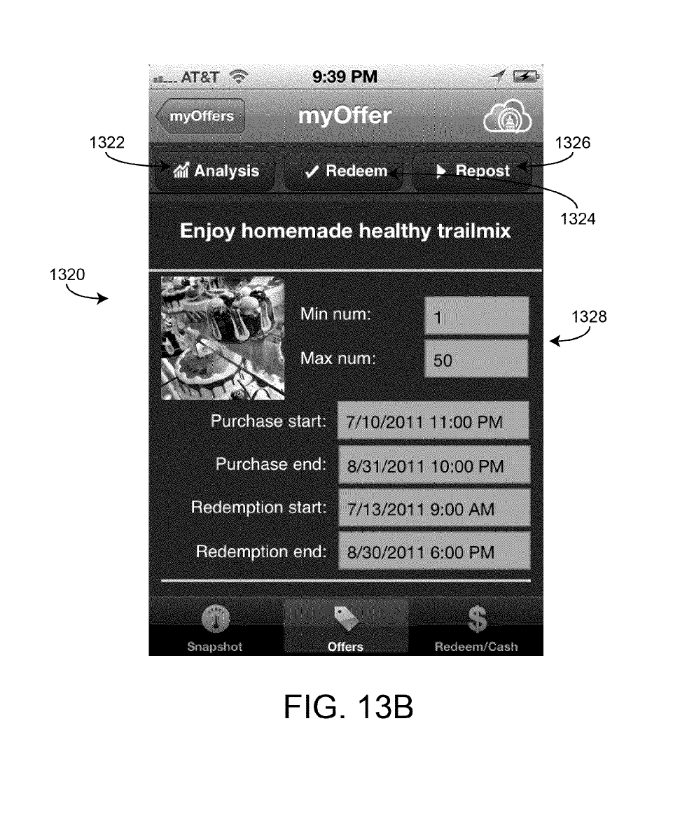

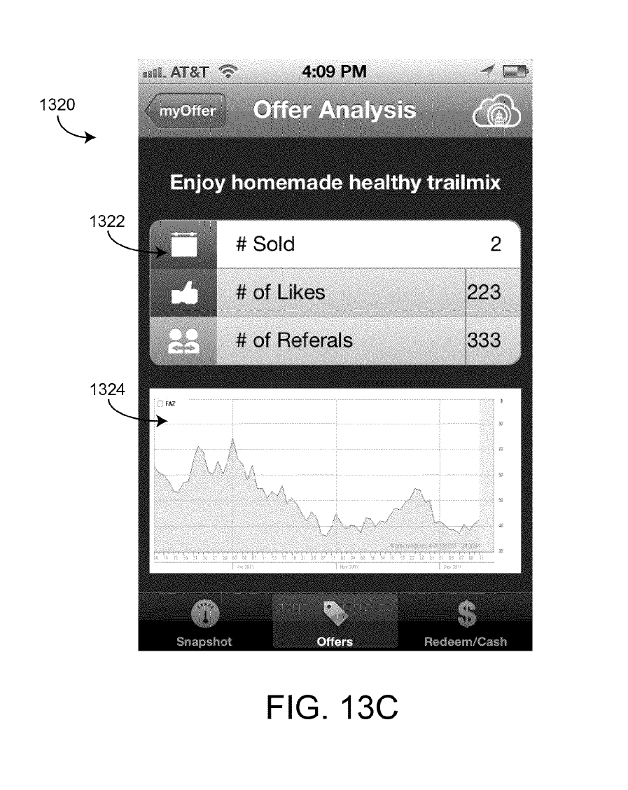

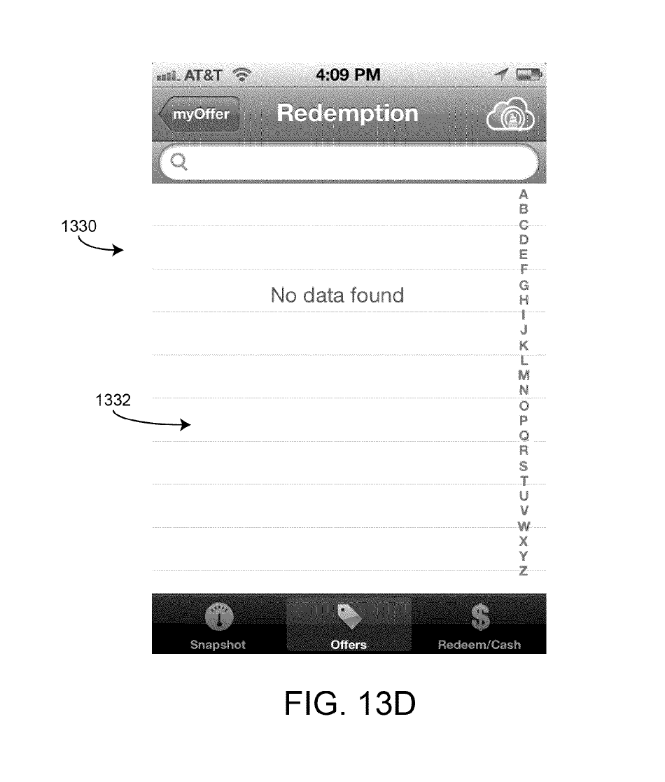

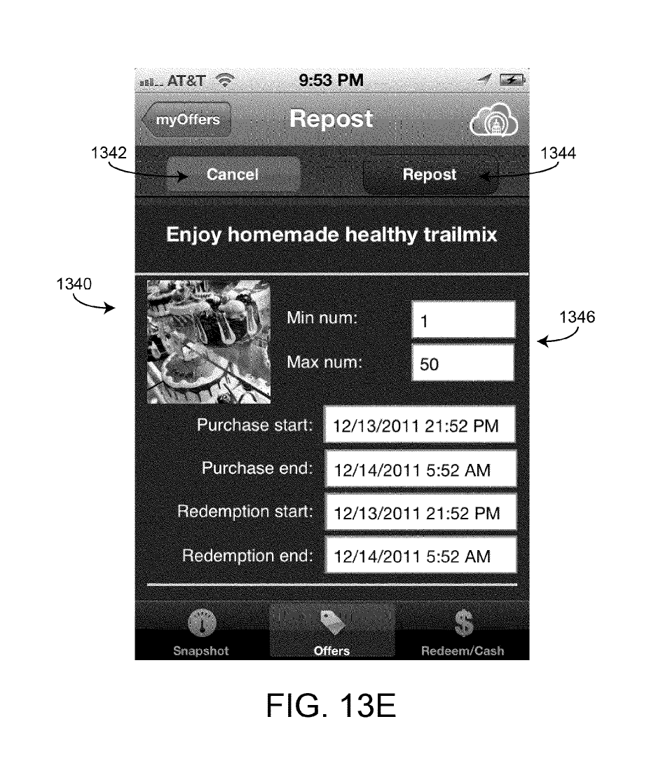

From the offer list or offer detail screen, the merchant may analyze the offer (step 526), edit the offer (step 528), or stop the offer (step 530). Analyzing the offer may include receiving information related to the offer, such as the number of times the offer was sold (step 532), the number of offer “likes” (step 534), or the number of offer referrals (step 536). The number of offer “likes” may relate to the number of times a customer indicated that he/she liked the offer or was satisfied by the product or service provided by the offer. The number of offer referrals may refer to the number of times a customer referred or shared the offer with another customer. Steps 532-536 are shown in greater detail in FIG. 13C.

Editing the offer may include editing the number of available deals (step 538). Editing the number of available deals may include determining how much of the offer should be made available or sold before the offer runs out. Editing the offer may include editing a deal end date (step 540) or redeem by date (step 542). Such dates may be part of the scheduling information of the offer. Steps 538-542 are shown in greater detail in FIG. 13B. Stopping the offer may simply include stopping the offer from being published or sold. This step is shown in greater detail in FIG. 13E.

The merchant may choose to view the redemption UI (step 550). The redemption UI allows the merchant to redeem purchased offers (e.g., to receive funds from the customer who purchased the offer). The redemption process may include various types of redemption. For example, the merchant may access a cash UI (step 552) that allows the merchant to be redeemed for the offer using cash (e.g., a deposit into a merchant account, a check, credit in a merchant account in the computer system). As another example, the merchant may access a call UI (step 554) that allows a merchant to call a phone number and to enter a code to redeem the offer. As another example, the merchant may access a scan UI (step 556) that allows a merchant to scan a bar code or another object. The scan may then be sent to the computer system for redemption. As another example, the merchant may access a search UI (step 558) that allows a merchant to search for offers that the merchant can redeem.

The merchant may choose to view the account UI (step 560) which is shown in greater detail in FIG. 11. The merchant may sign in or out at the account UI (step 562).

Referring generally to FIGS. 6-14, various graphical user interfaces are shown that illustrate the various features of system 150. Using the various graphical user interfaces of FIGS. 6-14, a merchant may manage and analyze offers. The graphical user interfaces may be provided on a browser on a laptop, desktop, or mobile device, or may be provided on an application on a mobile phone or other handheld device.

Referring now to FIG. 6, an illustration of a graphical user interface 600 for the computer system of FIG. 1 is shown, according to an exemplary embodiment. UI 600 may serve as a merchant UI homepage, according to an exemplary embodiment. UI 600 includes a button 602 that allows a merchant to create a new offer. UI 600 further includes various tabs 604 that allows the merchant to select other merchant UIs available to the merchant such as a snapshot UI, offers UI, or other UIs as described in FIG. 5.

UI 600 includes a deals window 606 that provides a merchant with current offer information. The offer information may include the name of the offer, a code or ID of the offer, how many of the offer have been sold and/or redeemed, an expiration date for the offer, the status of the offer, and one or more icons that can be selected, allowing the merchant to view further offer details.

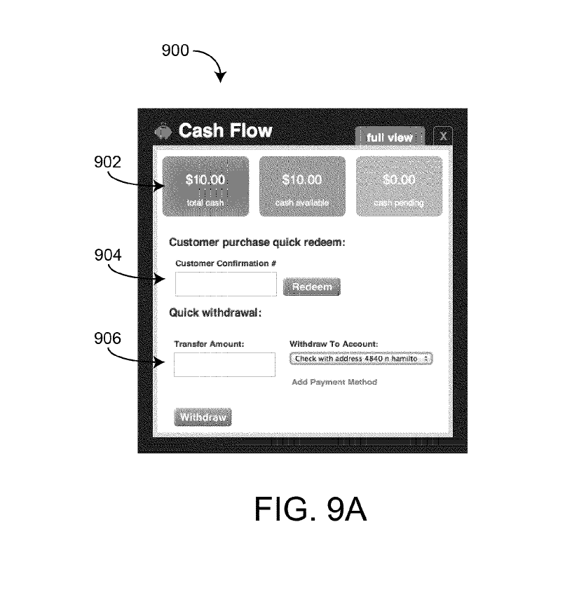

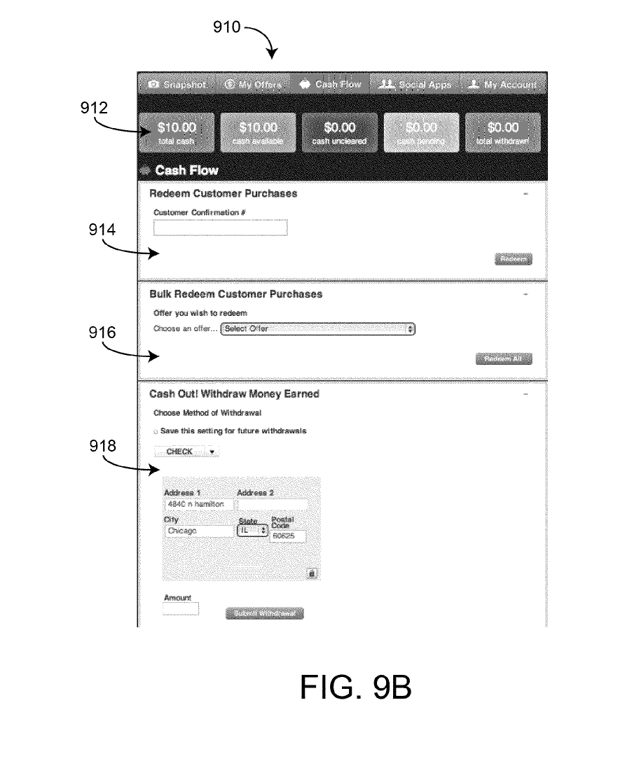

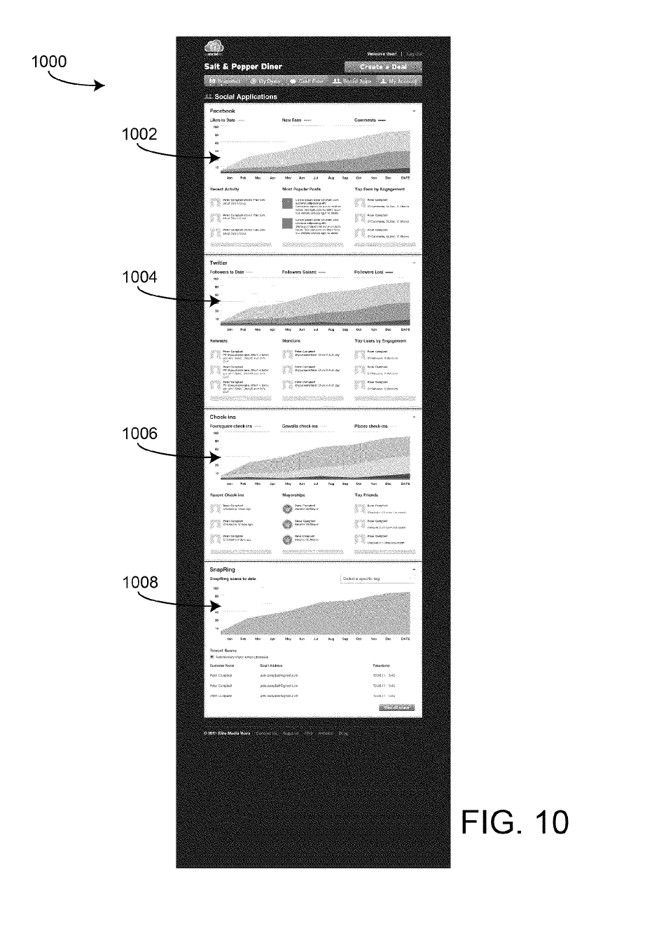

UI 600 further includes various windows 608-618 that allows the merchant to view offer analytics. For example, window 608 may be a general cash flow window that allows the merchant to view the cash available to the merchant. Upon selection on window 608, the merchant may access a UI (e.g., UI 900 of FIG. 9A) dedicated to cash flow. Windows 610, 612 may be related to various social media sites and performance of the offers and other merchant information. For example, in window 612, the merchant can see how many followers the merchant has, the number of times the merchant has been mentioned on the site, etc. Window 616 may be a window that allows the merchant to view statistics related to the merchants and their offers.

Window 618 may be a window that allows the merchant to view the snap ring tool. The snap ring tool is shown to display the total number of scans a merchant has made (e.g., a scan of a QR code or bar code). The snap ring tool further displays the number of contacts collected as part of a scan. Contacts may include SMS contacts, e-mail contacts, or any other type of contact that allows the merchant to interact with a customer. The snap ring tool may further include a graph detailing the number of scans, or any other display related to the scanning activities of the merchant.

The merchant may select any of the windows 608-618 to be taken to a new UI that provides more detail on the particular subject. Some windows may be hidden or blocked on UI 600; for example, merchant access to a particular tool may be restricted if the merchant has not purchased access to the tool.

When the merchant selects to create an offer using button 602, the merchant is taken to an offer creation UI. Referring now to FIGS. 7A-D, illustrations of graphical user interfaces for creating merchant offers are shown, according to an exemplary embodiment. The offer creation UI may include four general categories: business information 702, offer information 704, offer redemption 706, and scheduling and display options 708. In FIG. 7A, the business information window 702 is shown in greater detail. The merchant may provide business information such as a name and address in fields 710 and a category and sub-category which defines the types of products or services offered by the merchant in fields 712.

Referring to FIG. 7B, offer information may be provided in window 704. Offer information may include a price or product value for the offer in field 720. Offer information may further include schedule information (e.g., when to make the offer available for purchase) in field 722. Offer information may include a desired number of customers (e.g., the number of times the offer may be sold) and voucher information (e.g., how many vouchers for the offer to provide the customer upon purchase of the offer) in fields 724. Offer information may include one or more pictures that represent the offer in field 726. Offer information may include an offer description in field 728. Offer terms and conditions (e.g., if the offer can be transferred to another user, how many of an offer a customer can buy, etc.) may be specified in fields 730-732 (either via checkboxes or via a text box input).

Referring to FIG. 7C, offer redemption information may be provided in window 706. The merchant may specify when an offer can be redeemed (e.g., an offer start date and end date) in fields 750. The merchant may further specify a location at which the offer can be redeemed, if necessary, at fields 752.

Referring to FIG. 7D, scheduling and display options for the offer may be provided in window 708. The merchant can choose whether to put the offer up for bidding or for direct purchase via field 760. The merchant can choose a minimum bid on the offer if the offer is to be put up for bidding. The merchant can choose whether to make the offer public or private at field 762. For example, a public offer may be made available to all viewers of a website, to all users of a particular application, etc. Private offers may only be made available to particular customers or websites defined by the merchant. The merchant can choose to repeat the offer or end the offer upon sale of the offer using fields 764. For example, if an offer sells, the merchant can choose to no longer publish the offer, to no longer publish the offer after it is sold a specific number of times, to repeat the offer once a month (e.g., put the offer up for bidding every month and sell the offer to the highest bidder once a month), etc. The merchant can enter a URL relating to the offer using field 766.

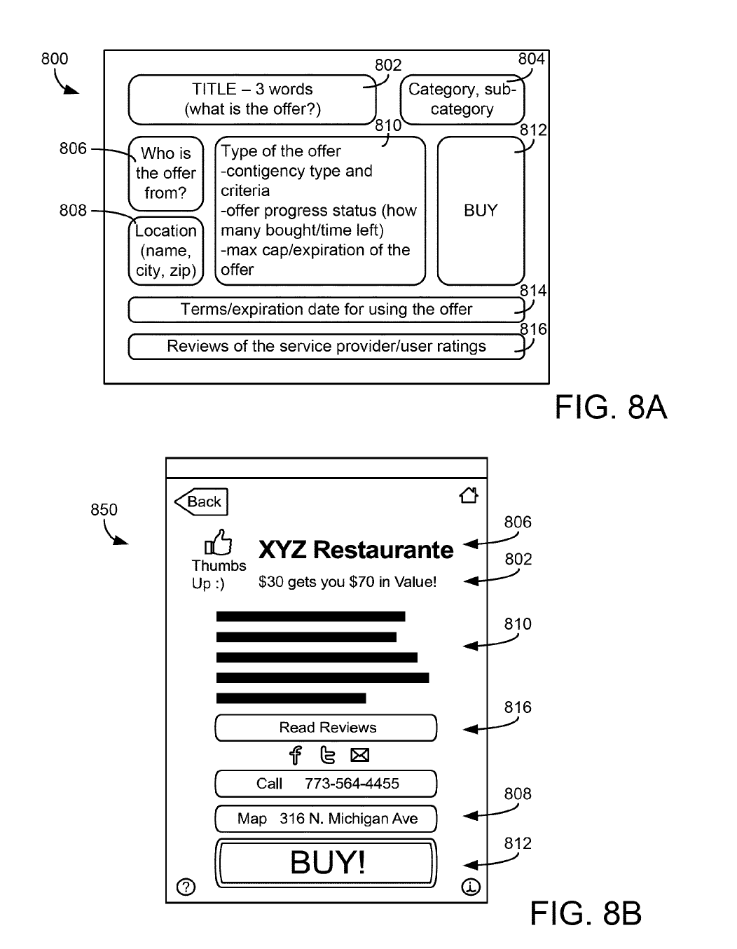

Following the entering of offer information in the windows of FIGS. 7A-D, the merchant can then choose to provide the offer to the computer system for publishing. Further, the merchant can choose a layout of the offer (e.g., how the offer appears on website or other site). For example, referring to FIG. 8A, a template 800 of an offer layout is shown. The merchant may use template 800 to determine what information of the offer to show, the location of the information in the offer window, etc. For example, in FIG. 8A, offer information may include a title 802, category and sub-category 804 the offer falls into, the offer provider 806, the location 808 of the offer, the type 810 of offer, buy button 812, terms 814 of the offer, and reviews 816 of the offer. Using template 800, the merchant may customize the look of the offer window.

An example “finished” offer window is shown in FIG. 8B. Offer window 850 includes some of the information that may be entered using template 800, and the information is rearranged based on the merchant's input. For example, the merchant has moved the offer provider 806 and offer title 802 to the top of window 850, the offer type 810 is described below, the customer may click a button to read reviews 816 of the offer, the location 808 is listed further down, and the buy button 812 is provided at the bottom of window 800. The merchant may be able to customize the look of the offer window and determine which offer information is to be displayed to the customer.

The merchant, after entering all information and submitting the offer, may receive confirmation of the offer. The confirmation may include one or more links at which the offer is made available. Further, the merchant may, after publishing the offer, send the offer and offer link to one or more e-mail contacts (or otherwise to customers via other social media sites). In one embodiment, the merchant may create a custom e-mail campaign, sending e-mails to subscribed customers that promote the offer just published.

Referring now to FIGS. 9A-B, illustrations of graphical user interfaces for merchant cash flow management is shown, according to an exemplary embodiment. In FIG. 9A, The merchant may access a cash flow UI 900 upon selecting window 608 of FIG. 6. Cash flow UI 900 includes an indication 902 of the total funds in the merchant account (e.g., a funds belonging to the merchant in the computer system), the funds available to the merchant (e.g., funds from customer purchases that have been redeemed by the merchant), and the funds pending (e.g., funds that have been cleared to the merchant but not yet redeemed by the merchant).

The merchant may enter a customer confirmation number in field 904. The confirmation number may be a number on the voucher that the customer used to obtain the offer, according to an exemplary embodiment. The merchant may enter the number in order to redeem a customer purchase. For example, when a customer purchases an offer, the customer may provide a purchase number to the merchant, and the merchant may provide the purchase number to the computer system for redemption. The merchant account may then be credited. The merchant may further withdraw funds from the merchant account using field 906. The merchant may specify which account to withdraw funds to, or another withdrawal procedure.

Referring now to FIG. 9B, another example of a UI for merchant cash flow management is shown. Cash flow UI 910 includes an indication 912 of the total funds in the merchant account (e.g., funds belonging to the merchant in the computer system), the funds available to the merchant (e.g., funds from customer purchases that have been redeemed by the merchant), the funds uncleared (e.g., funds from customer purchases that have not been cleared yet), the funds pending (e.g., funds that have been cleared to the merchant but not yet redeemed by the merchant), and the funds withdrawn (e.g., payments made to a merchant account). The total funds field may simply represent the total of all other fields in indication 912, according to an exemplary embodiment. The merchant can redeem a customer confirmation number in field 914 as described above. The merchant can further redeem all purchases for a given order using field 916. For example, the merchant can select an offer, and all purchases on the offer may then be redeemed and instantly credited to the merchant account (without having to individually confirm vouchers with a confirmation number). The merchant may further withdraw funds from the merchant account using fields 918. In FIG. 9B, the merchant may be provided with options to receive a check instead of having an account credited.

Referring now to FIG. 10, illustration of a graphical user interface 1000 for analysis of offer performance on social media sites is shown, according to an exemplary embodiment. UI 1000 includes various windows 1002-1008 illustrating offer performance on different sites. For example, window 1002 may be for a social networking service that allows users to post content, “like” content, and share content with other users. Window 1002 includes a graph indicating how many “likes” the merchant or offer has received, the number of “fans” of the merchant or offer, and the number of comments made on the merchant or offer by the users of the site. Window 1002 may further include recent activity by users that relates to the merchant or offer, user posts that relate to the merchant or offer, etc. The data provided in windows 1002-1008 may be tailored to the individual social media site (e.g., since different social media sites allow for different kinds of interactions between users and merchants, the type of data provided in windows 1002-1008 may vary).

As one example, for a social media site such as Facebook, the offer performance analysis may include a graph illustrating the number of times an offer or merchant was “liked”, the number of “fans” of the offer or merchant, and the number of wall posts about the offer or merchant. Further, the analysis may include a list of recent activity that references the offer or merchant. For example, in window 1002, a list of recent wall posts, a list of users who most recently shared a link to the offer, or a list of the “top fans” of the offer based on comments, “likes”, and sharing of the offer may be provided. In another example, for a social media site such as Twitter, the offer performance analysis may include a graph illustrating the number of tweets related to the offer or merchant, the number of followers of a Twitter account associated with the offer or merchant, the number of followers gained or lost, etc. Further, the analysis may include a list of tweets related to the offer. For example, in window 1004, a list of the most recent retweets that are related to a particular merchant tweet or merchant account, a list of the most recent mentions, and list of the top users who retweet or mention the merchant or offer are listed. It should be understood that the type of analysis provided in windows 1002-1008 may be tailored to the type of social media site, the type of activities a customer or merchant may perform on the social media site, etc.

Referring now to FIG. 11, an illustration of a graphical user interface for managing merchant account information is shown, according to an exemplary embodiment. UI 1100 may be used by a merchant to enter merchant information. For example, a merchant may enter user profile information in window 1102. The merchant may upload an image to represent the merchant, along with a display name for the merchant, a password to be used for merchant access to the system, and a user name and e-mail address for the user of the merchant account. The merchant image and display name may be used by the computerized system to represent the merchant when a merchant offer is displayed to a customer.

The merchant may enter a business profile at window 1104. The business profile may include the merchant name, merchant address, merchant phone number, a website or blog address of the merchant, and one or more images to represent the merchant.

The merchant may enter a social profile at window 1106. The merchant may have a profile on one or more social media sites, and may allow the computerized system access to such social media sites. This may allow the computerized system to provide information to the merchant for display on the merchant's social media sites. The merchant may enter a URL of the merchant social media site along with credential information that allows the computerized system to gain access to the social media sites.

Referring now to FIG. 12, an illustration of a graphical user interface for a merchant homepage is shown, according to another embodiment. UI 1200 is shown as a user interface for a mobile device. UI 1200 is shown as a snapshot UI as described in FIG. 5. UI 1200 includes a window 1202 that allows a merchant to select an offer tool, snap ring tool, or social platform tool. UI 1200 includes a window 1204 that displays analytic information to the merchant. UI 1200 includes a window 1206 that allows the merchant to select between a snapshot UI, offer UI, or redemption UI to view.

If the merchant selects the offer UI, the merchant may be taken to the UI 1300 of FIG. 13A. UI 1300 is a user interface displaying merchant offers in window 1306. The merchant may use buttons 1302, 1304 to view offers that are currently active or inactive. For example, button 1304 is selected in UI 1300, so only inactive offers are displayed in window 1306. The list of offers is scrollable and sortable, according to an exemplary embodiment.

A merchant may select an offer on UI 1300 and choose to analyze the offer on a UI 1310 shown in FIG. 13B. On UI 1310, the merchant may view offer details in window 1318, and may be able to modify the details if the offer is inactive. The merchant may choose to analyze performance of the offer (using button 1312), redeem the offer (using button 1314), or repost the offer (using button 1316). For example, upon selecting button 1312, the merchant may be taken to UI 1320 of FIG. 13C. On UI 1320, the merchant may view offer information in window 1322 (e.g., the number of offers sold, the number of “likes” of the offer, the number of offer referrals, etc.). The merchant may further view a graph of offer performance or other offer information in window 1324.

Upon selecting button 1314, the merchant may be taken to UI 1330 of FIG. 13D. On UI 1330, the merchant may view data regarding how many customers have redeemed the offer in window 1332. Upon selecting button 1316 (if the offer is inactive), the merchant may be taken to UI 1340 of FIG. 13E. On UI 1340, the merchant may choose to cancel the offer using button 1342 or repost the offer (e.g., publish the offer) using button 1344. Further, the merchant may edit the offer using window 1346.

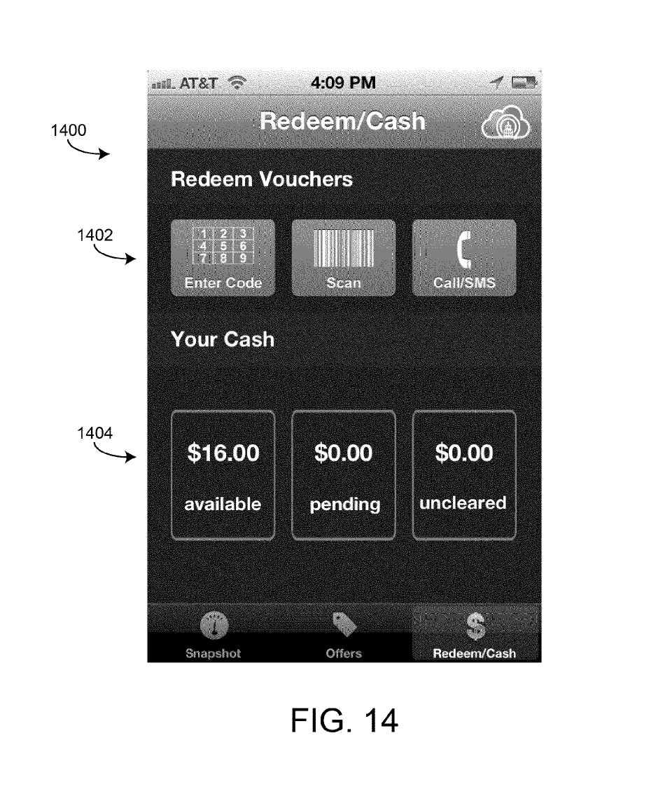

Referring now to FIG. 14, an illustration of a graphical user interface 1400 for merchant offer redemption is shown, according to an exemplary embodiment. The merchant may select a type of redemption using one of the buttons 1402. For example, the merchant may enter a voucher code, may scan a bar code, may call in a voucher code, or redeem a voucher in another way. The merchant can also view current merchant account information in window 1404 as described previously.

The user interfaces of FIGS. 6-14 may generally include navigation buttons that allow the user to access various functions of the system. For example, a navigation button may be provided that allows the user to go to a home page or other user interface of the system (via a home icon), and a FAQ button may be provided that allows the merchant to access help topics for using the user interface (via a question mark icon).

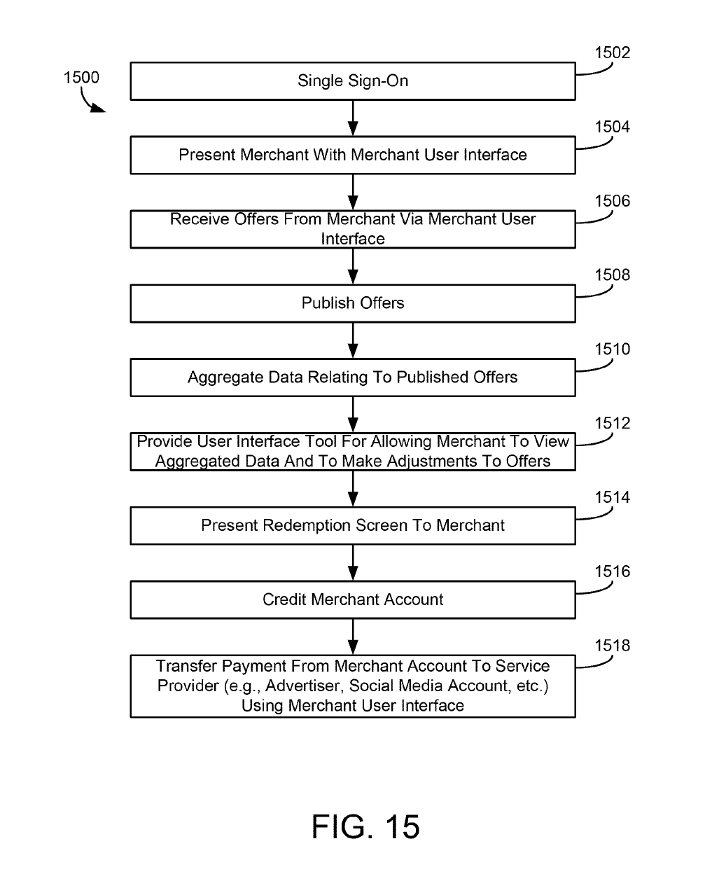

Referring now to FIG. 15, a flow chart of a process 1500 of computerized system interaction with a merchant is shown, according to an exemplary embodiment. Process 1500 includes receiving a single sign-on from a merchant (step 1502). At step 1502, the merchant signs into the system. In one embodiment, the sign-on process may include the merchant entering a single username, password, and/or other identifier and being signed onto the computerized system. The business layer can sign the user onto the various social networking sites or other sites that are used to populate dashboards or merchant user interfaces. For example, a single sign-on may provide merchant access to the marketplace's computerized system and related databases, a Facebook account, and a Twitter account. Process 1500 includes presenting a merchant with a merchant user interface (step 1504) (e.g., via merchant UI module 164 as described above). The merchant user interface allows the merchant to enter an offer and offer information. The computerized system may receive the offers from the merchant via the merchant user interface (step 1506). The offers may then be provided to, for example, business layer 168 for preparing for publishing.

The merchant may then publish the offers (step 1508). The offers may be published based on merchant preferences (e.g., based on a schedule specified by the merchant, based on customer bidding or purchasing preferences specified by the merchant, etc.). The computerized system may aggregate data relating to the published offers (step 1510). The data may relate to the number of offers sold, the number of offer views, the number of times a customer interacted with the offer by “liking” or sharing the offer, etc. The data may be aggregated by, for example, the various modules of business layer 168 as described in FIG. 2.

The computerized system may provide a user interface tool for allowing the merchant to view aggregated data and to make adjustments to the offers (step 1512). The user interface tool may be similar to the user interface tools shown in FIGS. 6-14, according to one embodiment.

Process 1500 further includes presenting a redemption screen to the merchant (step 1514). The redemption screen allows the merchant to view offers that have been redeemed by customers and merchant account information. The redemption screen may be similar to, for example, user interface 910 of FIG. 9B. Process 1500 further includes crediting the merchant account (step 1516). Crediting the merchant account may include transferring pending funds for the redeemed voucher to the merchant's account. Crediting the merchant account may further include transferring other funds to the merchant related to the sale of merchant offers or otherwise. Some merchants may receive bonuses or incentives, for example, for signing up other merchants or for driving traffic to the marketplace computer's web sites.

Process 1500 further includes transferring money from a merchant account to a service provider (e.g., an advertiser or social media account) using the merchant user interface (step 1518). When a merchant chooses to publish an offer with a premium advertiser or social media outlet, the merchant may be charged for publishing the offer. At step 1518, the merchant may use the merchant user interface to transfer money from the merchant account to the service provider. For example, when an offer is redeemed, the merchant may be credited in the merchant account and the merchant may then use a portion of the credited funds to pay charges other service providers (e.g., telephone companies, web-providers, etc.). The transfer may also be effected from the merchant account to a bank account for the merchant. Step 1518 may also include the computerized system automatically deducting a fee from the total funds that were to be provided to the merchant.

### Configurations of Various Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computer system for e-commerce management, comprising:
a merchant user interface module configured to allow a merchant to define a deal for offering via a plurality of online distribution channels; and
a business layer configured to use the defined deal to publish offers of the defined deal to the plurality of online distribution channels;
wherein the business layer aggregates data relating to the published offers and the plurality of online distribution channels;
wherein the merchant user interface module is further configured to allow the merchant to view the aggregated data and to make adjustments to the published offers.

2. The computer system of claim 1, further comprising a consumer user interface module that provides user interface information for publishing the offer and for serving as one of the plurality of online distribution channels;
wherein the merchant user interface and the business layer allow the user to publish the offers of the defined deal to the consumer user interface without approval or interaction from an e-commerce administrator.

3. The computer system of claim 1, wherein the plurality of distribution channels comprises a social media site and wherein the computer system further comprises a module configured to track activity relating to the deal on the social media site.

4. The computer system of claim 1, wherein the plurality of distribution channels comprise a mobile application, a web-based user interface, and at least one social media site.

5. The computer system of claim 1, wherein the merchant user interface module is configured to provide a merchant dashboard comprising:
a list of deals;
a social media tracker;
a cash flow manager; and
an analytics tool.

6. The computer system of claim 5, wherein the list of deals comprises a description of the number of deals sold and the number of deals redeemed.

7. The computer system of claim 5, wherein social media tracker comprises a count of a number of interactions with the merchant's social media account.

8. The computer system of claim 5, wherein the cash flow manager comprises a description of the money received from consumers for the merchant.

9. The computer system of claim 5, wherein the analytics tool comprises a description of browsing traffic associated with the merchant's deal or deals.

10. A computerized method for providing e-commerce management, comprising:
presenting a merchant with a merchant user interface that allows the merchant to define a deal for offering via a plurality of distribution channels;
publishing offers of the defined deal to a plurality of online distribution channels;
aggregating data relating to the published offers and the plurality of online distribution channels; and
providing, via the merchant user interface, a user interface tool for allowing the merchant to view the aggregated data and to make adjustments to the published offers.

11. Computer-readable media having instructions stored thereon, which, when executed by a data processing apparatus, causes the data processing apparatus to perform operations comprising:
presenting a merchant with a merchant user interface that allows the merchant to define a deal for offering via a plurality of distribution channels;
publishing offers of the defined deal to a plurality of online distribution channels;
aggregating data relating to the published offers and the plurality of online distribution channels; and
providing, via the merchant user interface, a user interface tool for allowing the merchant to view the aggregated data and to make adjustments to the published offers.
